(19) United States
(12) Patent Application Publication
(10) Pub. No.: US 2014/0368783 A1
(43) Pub. Date: Dec. 18, 2014

(54) LIQUID CRYSTAL MODULATOR AND INSPECTION APPARATUS HAVING THE SAME

(71) Applicant: Samsung Display Co., Ltd., Yongin-city (KR)

(72) Inventors: Suk Choi, Seongnam-si (KR); Ohjeong Kwon, Hwaseong-si (KR); Sujin Kim, Seoul (KR); Jinwon Kim, Suwon-si (KR); SeungWook Nam, Cheonan-si (KR); Jooyoung Yoon, Suwon-si (KR); Hyeokjin Lee, Seongnam-si (KR)

(73) Assignee: Samsung Display Co., Ltd., Yongin-city (KR)

(21) Appl. No.: 14/069,203

(22) Filed: Oct. 31, 2013

(30) Foreign Application Priority Data
Jun. 12, 2013 (KR) 10-2013-0067217

(51) Int. Cl. G02F 1/13

(52) U.S. Cl. CPC G02F 1/1309
USPC 349/199

(57) ABSTRACT

In an aspect, a liquid crystal modulator for an inspection apparatus for detecting a defect of a substrate is provided which includes a first substrate; an electrode provided on the first substrate; and a sensor layer provided between the first substrate and the electrode is provided. The sensor layer includes a polymer-stabilized blue phase liquid crystal.

### INCORPORATION BY REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0067217 filed in the Korean Intellectual Property Office on Jun. 12, 2013, the disclosure of which is hereby incorporated by reference in its entirety.

### BACKGROUND

1. Field

This disclosure relates to a liquid crystal modulator and an inspection apparatus including the liquid crystal modulator, and more particularly, relate to a liquid crystal modulator included in an inspection apparatus capable of detecting a defect of a substrate and an inspection apparatus including the same.

2. Description of the Related Technology

Display devices such as a liquid crystal display (LCD), an organic light emitting display (OLED), or a plasma discharge panel (PDP) have been developed. The display devices may be high-definition, ultra-thin, and light, and may have a wide viewing angle characteristics.

In general, a display device may include pixels for showing an image. Each pixel may include a pixel electrode and a driving circuit (e.g., a thin film transistor) electrically connected to the pixel electrode in a one-to-one correspondence manner. It is advisable to test for defects of the pixel electrodes and the driving circuits of a display device to maintain high quality during manufacturing.

### SUMMARY

Some embodiments provide a liquid crystal modulator which may be used as an inspection apparatus to detect a defect of a substrate. In some embodiments, the liquid crystal modulator comprises a first substrate; an electrode provided on the first substrate; and a sensor layer provided between the first substrate and the electrode. In some embodiments, the sensor layer includes a polymer-stabilized blue phase liquid crystal.

In some embodiments, the polymer-stabilized blue phase liquid crystal comprises a blue phase liquid crystal, a reactive mesogen, and a polymer binder.

In some embodiments, the polymer-stabilized blue phase liquid crystal contains the blue phase liquid crystal and reactive mesogen in a range from 6:4 to 8:2 (blue phase liquid crystal:reactive mesogen) by weight.

In some embodiments, the polymer binder may be one selected from a group of a polyamide polymer binder, a polythioether polymer binder, and a polycyanurate polymer binder.

In some embodiments, a refractive index anisotropy of the blue phase liquid crystal may be more than about 0.1. In some embodiments, a pitch of the blue phase liquid crystal may be between about 270 nm and about 300 nm. In some embodiments, a wavelength of a reflection peak of the blue phase liquid crystal may be between 400 nm and 500 nm.

Some embodiments provide an inspection apparatus which detects a defect of a substrate. In some embodiments, the inspection apparatus comprises the liquid crystal modulator provided on the substrate; a light emitting unit provided to be spaced apart from the liquid crystal modulator; a beam splitter provided between the liquid crystal modulator and the light emitting unit; and a measurement unit disposed to be opposite to the liquid crystal modulator with the beam splitter being interposed between the measurement unit and the liquid crystal modulator. In some embodiments, the beam splitter is configured to reflect a light from the light emitting unit to the liquid crystal modulator and the measurement unit is configured to sense a light from the liquid crystal modulator.

In some embodiments, the inspection apparatus may further comprise a focusing unit provided between the beam splitter and the measurement unit and focusing the light.

In some embodiments, the inspection apparatus may further comprise an image processing unit converting a signal generated by the measurement unit into an image.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a diagram schematically illustrating an inspection apparatus according to an exemplary embodiment;

FIG. 2 is a cross-sectional view of a liquid crystal modulator MD of FIG. 1, according to an exemplary embodiment;

FIG. 3 is a graph schematically illustrating kinds of a blue phase liquid crystal;

FIG. 4 is a perspective view of a first blue phase liquid crystal of FIG. 3, according to an exemplary embodiment;

FIG. 5 is a diagram schematically illustrating a driving principle of a liquid crystal modulator MD, according to an exemplary embodiment;

FIGS. 6A and 6B are diagrams showing structures of blue phase liquid crystals according to whether an electric field E is provided, according to an exemplary embodiment;

FIG. 7 is a graph showing a wavelength of a reflection peak according to a pitch of a blue phase liquid crystal; and

FIG. 8 is a graph showing a reflection ratio of a wavelength of a blue phase liquid crystal according to an exemplary embodiment.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the embodiments to those skilled in the art. Accordingly, known processes, elements, and techniques may not be described with respect to some of the exemplary embodiments. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiment.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it may be the only layer between the two layers, or one or more intervening layers may also be present.

The terminology used herein is for the purpose of describing particular embodiments only and is not intended to be limiting of the exemplary embodiment. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

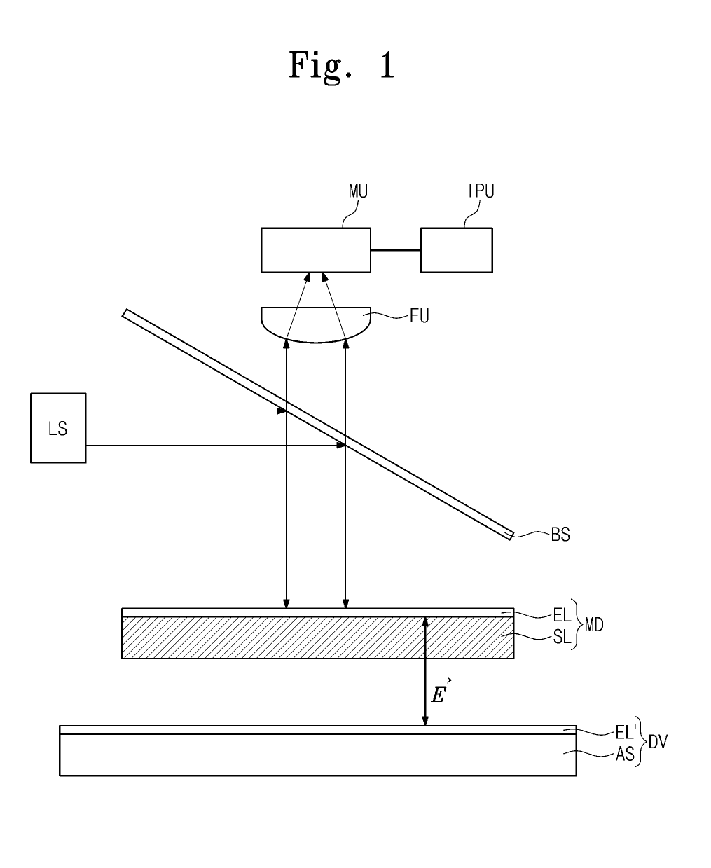

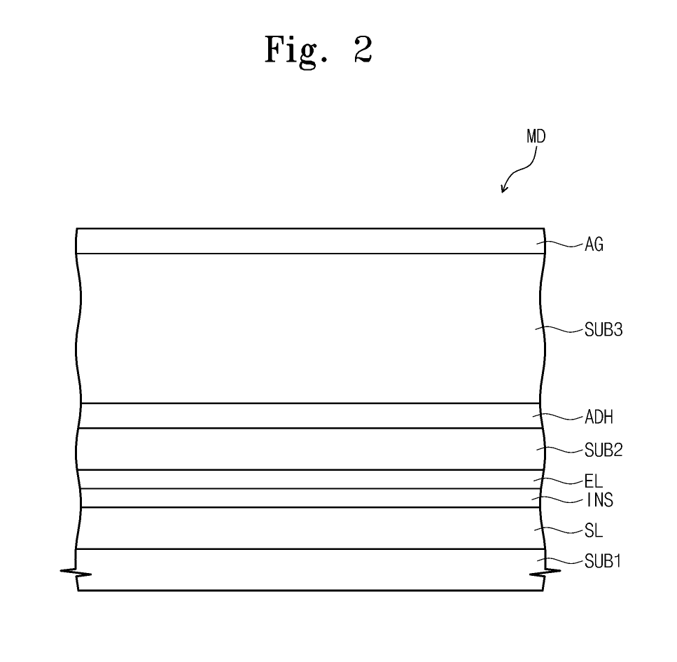

FIG. 1 is a diagram schematically illustrating an inspection apparatus according to an exemplary embodiment. FIG. 2 is a cross-sectional view of a liquid crystal modulator MD of FIG. 1, according to an exemplary embodiment.

Referring to FIGS. 1 and 2, an inspection apparatus may be a defect of a display device, in particular, a defect of a display substrate DV used for the display device. The display device may not be limited to a specific kind. For example, the display device may include a liquid crystal display device, an electrowetting display device, an electrophoretic display device, an organic light emitting display device, etc.

In some embodiments, the display device may include a plurality of pixels. In some embodiments, the display device may further comprise, an opposite substrate (not shown) opposite to the display substrate DV, and an image display layer (not shown) disposed between the display substrate DV and the opposite substrate. In some embodiments, the image display layer may be a liquid crystal layer of the liquid crystal display device, an electrowetting layer of the electrowetting display device, an electrophoretic layer of the electrophoretic display device, or an organic light emitting layer of the organic light emitting display device. In some embodiments, the opposite substrate may be replaced with an encapsulation layer according to a kind and a structure of the display device.

In some embodiments, the display substrate DV may be used for a liquid crystal display device, for example, the display substrate DV may be used for a liquid crystal display device having modes such as a plane to line switching (PLS) mode, a fringe field switching (FFS) mode, a vertical alignment (VA) mode, a twisted nematic (TN) mode, a patterned vertical alignment (PVA) mode, and an in-plane switching (IPS) mode.

In some embodiments, the display substrate DV may include the array substrate AS and a target electrode EL′ formed on the array substrate AS. In some embodiments, the target electrode EL′ may be provided in plurality to correspond to pixels, respectively.

Although not shown, the array substrate AS may include an insulation substrate and a plurality of driving circuits (e.g., thin film transistors) disposed on the insulation substrate. the driving circuits may be electrically connected to a part of the target electrodes EL′ to apply a predetermined voltage (e.g., about 10V) to the target electrodes EL′.

Below, components and an operating principle of the inspection apparatus will be described.

The inspection device according to an exemplary embodiment may include a light emitting unit LS, a beam splitter BS, a liquid crystal modulator MD, a focusing unit FU, a measurement unit MU, and an image processing unit IPU.

The light emitting unit LS outputs a light. In some embodiments, the light emitting unit LS may include a variety of light sources such as a light emitting diode, a cathode ray fluorescence ramp, etc. Although not shown, the light emitting unit LS may include a light guide member such as a light guide plate that guides the light toward the beam splitter BS.

The beam splitter BS splits the light provided from the light emitting unit LS into a plurality of light components to be provided toward the liquid crystal modulator MD. In some embodiments, the split lights may proceed to correspond to different locations of the display substrate DV. In some embodiments, the split lights may be reflected by the liquid crystal modulator MD or the display substrate DV. When the split lights are reflected by the liquid crystal modulator MD, they may penetrate the beam splitter BS to be provided the measurement unit MU. In some embodiments, the split lights may approximately correspond to locations of the opposite electrodes EL′, respectively.

In some embodiments, the liquid crystal modulator MD may be a component for checking whether pixels of the display substrate DV are defective. In some embodiments, the liquid crystal modulator MD is disposed above the display substrate DV so as to be spaced apart from the display substrate DV. The penetration ratio or reflex ratio of the liquid crystal modulator MD is variable according to whether the display substrate DV is defective. Whether the pixels are defective may be determined based on the penetration ratio or the reflex ratio. In some embodiments, the liquid crystal modulator MD may include an electrode EL (hereinafter, referred to as “an opposite electrode” for differentiation between an electrode of a substrate and the electrode EL) and a sensor layer SL.

In detail, the liquid crystal modulator MD according to an exemplary embodiment may include a first substrate SUB1, the opposite electrode EL provided above the first substrate SUB1, and the sensor layer SL provided between the first substrate SUB1 and the opposite electrode EL.

In more detail, the liquid crystal modulator MD according to an exemplary embodiment may include the first substrate SUB1, the sensor layer SL provided on the first substrate SUB1, the opposite electrode EL provided on the sensor layer SL, a second substrate SUB2 provided on the opposite electrode EL, a third substrate SUB3 opposite to the second substrate SUB2, and an anti-reflection layer AG provided on the third substrate SUB3.

In some embodiments, the first substrate SUB1 may be a transparent insulation substrate, and may be formed of a material such as quartz, glass, plastic, etc.

In some embodiments, the opposite electrode EL is supplied with a predetermined level of voltage (e.g., about 150V to 350V), and form an electric field E together with the target electrode EL′. In some embodiments, the opposite electrode EL may be formed of a transparent conductive material such as an indium tin oxide (ITO), an indium zinc oxide (IZO), an indium tin zinc oxide (ITZO), a conductive polymer, etc.

In some embodiments, an insulation layer INS may be provided between the opposite electrode EL and the sensor layer SL to protect the opposite electrode EL and to separate the opposite electrode EL and the sensor layer SL.

In some embodiments, a penetration ratio or a reflex ratio of the sensor layer SL may be variable according to the electric field E formed between the opposite electrode EL and the target electrode EL′, and the sensor layer SL may be formed of a liquid crystal layer. In the liquid crystal modulator MD according to an exemplary embodiment, the liquid crystal layer may include a polymer-stabilized blue phase liquid crystal. The polymer-stabilized blue phase liquid crystal will be described below.

In some embodiments, the second substrate SUB2 may be provided on the opposite electrode EL. Like the first substrate SUB1, the second substrate SUB2 may be a transparent insulation substrate, and may be formed of a material such as quartz, glass, plastic, etc.

Here, there is described an embodiment where the sensor layer SL, the insulation layer INS, the opposite electrode EL, and the second substrate SUB2 are sequentially stacked in this order. However, the embodiments are not limited thereto. For example, the second substrate SUB2 may be first prepared, and then the opposite electrode EL, the insulation layer INS, and the sensor layer SL may be sequentially stacked on the second substrate SUB2. In this case, the opposite electrode EL may be provided on the second substrate SUB2, and the second substrate SUB2 may support the opposite electrode EL.

In some embodiments, the third substrate SUB3 may be provided above the second substrate SUB2. In some embodiments, an adhesive ADH may be provided between the second substrate SUB2 and the third substrate SUB3 to tightly adhere the second substrate SUB2 and the third substrate SUB3. In some embodiments, the third substrate SUB3 may be an optically transparent material, and may be formed of a material such as quartz, glass, etc. In some embodiments, the third substrate SUB3 may support and protect lower components, that is, the first substrate SUB1, the sensor layer SL, the second substrate SUB2, etc.

In some embodiments, an anti-reflection layer AG may be provided on the third substrate SUB3.

In some embodiments, the focusing unit FU may be disposed above the beam splitter BS. In some embodiments, the focusing unit FU focuses the split light reflected by the liquid crystal modulator MD. In some embodiments, the focusing unit FU may be formed of a convex lens.

In some embodiments, the split lights focused by the focusing unit FU may be provided to the measurement unit MU. In some embodiments, the measurement unit MU may include a plurality of charge-coupled devices (CCDs). The measurement unit MU generates data signals each corresponding to the quantity of light of each of the split lights using the plurality of charge-coupled devices. In some embodiments, the split lights may be provided to correspond to a unit of three charge-coupled devices of the plurality of charge-coupled devices.

The image processing unit IPU converts the data signals generated by the measurement unit MU into images. Thus, an operator can determine whether each pixel electrode is defective, based on the images displayed through the image processing unit IPU.

Below, the polymer-stabilized blue phase liquid crystal will be described.

A blue phase liquid crystal is isotropic two-dimensionally or three-dimensionally when no electric field is applied thereto. If an electric field E is applied, the blue phase liquid crystal has a birefringence in a predetermined direction according to a direction of the electric field E. Thus, the blue phase liquid crystal becomes to have optically uniaxial characteristic when a voltage is applied thereto thereby the penetration ratio depends on a viewing angle. In some embodiments, the blue phase liquid crystal may be smectite or cholesteric.

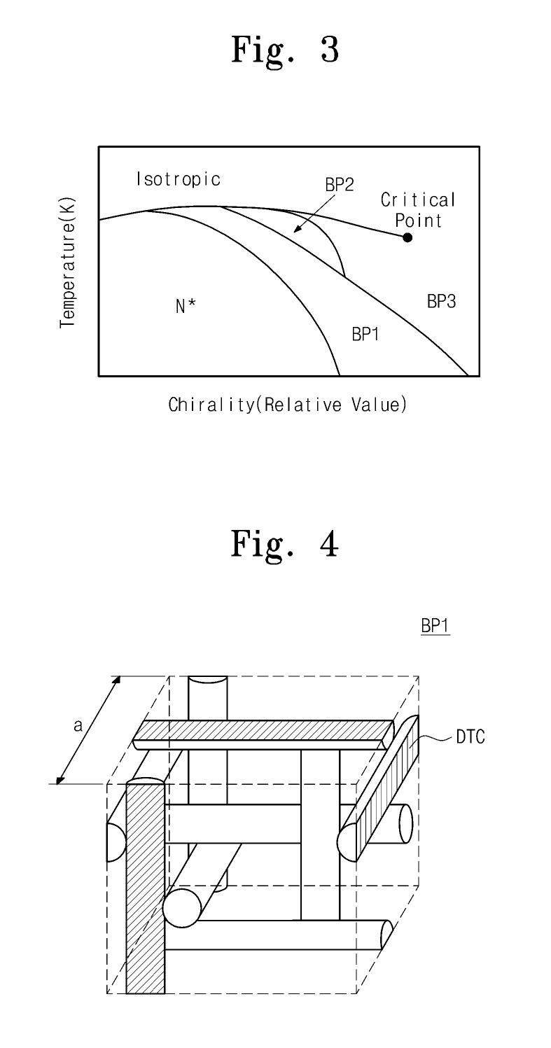

FIG. 3 is a graph schematically illustrating kinds of a blue phase liquid crystal. FIG. 4 is a perspective view of a first blue phase liquid crystal of FIG. 3, according to an exemplary embodiment. In FIG. 3, an x-axis indicates chirality, and a y-axis indicates a temperature. The chirality may be adjusted by controlling the amount of chiral dopant.

Referring to FIG. 3, the blue phase liquid crystal is shown within a specific temperature region between a chiral nematic phase N* and an isotropic phase. The blue phase liquid crystal includes a first blue phase liquid crystal BP1, a second blue phase liquid crystal BP2, and a third blue phase liquid crystal BP3. Arrangement of double twist cylinders DTC is variable according to a kind of the blue phase liquid crystal.

The first blue phase liquid crystal BP1 has wider temperature range than that of each of the second and third blue phase liquid crystal BP2 and BP3.

As illustrated in FIG. 4, the first blue phase liquid crystal BP1 includes liquid crystal molecules, liquid crystal directors of which are arranged in a form of double helix structure to form a double twist cylinder DTC, thereby the liquid crystal molecules have a body-centered cubic lattice structure. Below, each edge (a) of a cube having the body-centered cubic lattice structure is referred to a “pitch” of the blue phase liquid crystal.

In some embodiments, the blue phase liquid crystal may comprise the first blue phase liquid crystal BP1. In some embodiments, the blue phase liquid crystal may be combined with a polymer to form a polymer-stabilized blue phase liquid crystal. In some embodiments, the phase liquid crystal may be mixed with the polymer, thereby a lattice structure of the double twist cylinder DTC is stabilized. That is, if the blue phase liquid crystal is mixed with the polymer, the polymer may be combined well with liquid crystals forming the double twist cylinder DTC, which has no anisotropy. Thus, the lattice structure of the double twist cylinder DTC is stabilized, and a temperature region where the blue phase liquid crystal exists may expand from about 1° C. to about 5° C. to about 1° C. to about 60° C.

In some embodiments, the polymer-stabilized blue phase liquid crystal may include a blue phase liquid crystal, a reactive mesogen, a photoinitiatior, and a polymer binder.

The blue phase liquid crystal may not be limited to a specific liquid crystal. The blue phase liquid crystal according to an exemplary embodiment may include a liquid crystal corresponding to at least one of the following chemical formulas (I) to (III).

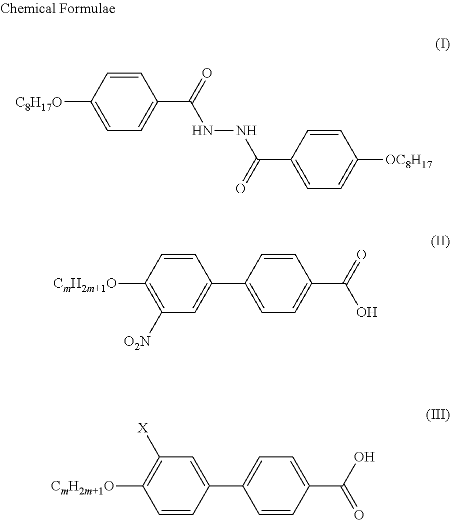

In the chemical formulas (I) to (III), m is an integer not being 0. In some embodiments, m is an integer more than 1 and less than or equal to 20. In some embodiments, X is —NO₂.

In an embodiment, the blue phase liquid crystal may include 4-cyano-4′-pentylbiphenyl. In another embodiment, the blue phase liquid crystal may be a mixture of liquid crystals in Chemical Formulae (I) to (III).

The reactive mesogen is a compound that reacts by a light (e.g., polymerization reaction), and may include a compound having carbon-carbon unsaturated bonds and carbon-carbon cyclic bonds. For example, the blue phase liquid crystal may include acrylic compounds such as 1,3-butylene glycol diacrylate, 1,4-butane diol diacrylate, ethylene glycol diacrylate, etc. In an some embodiment, a contacting ratio of the blue phase liquid crystal to the reactive mesogen may be 6:4 to 8:2 in weight. In another exemplary embodiment, a containing ratio of the blue phase liquid crystal to the reactive mesogen may be 7:3 in weight. In some embodiments, the reactive mesogen may be contained in the polymer-stabilized blue phase liquid crystal under a condition where the reactive mesogen is hardened by light such as an ultraviolet light. When adding the reactive mesogen, a driving temperature of the blue phase liquid crystal can be higher.

In some embodiments, the photoinitiator may be a photopolymerization initiator, and may include at least one acetophenone compound. For example, diethoxy acetophenone, 2-metal-2-monopoly-1-(4-methylthiophenyl)propane-1-one, 2-hydroxy-2-metal-1-phenylpropan-1-one, etc. may be included in the photoinitiator. Also, a benzoin compound, a benzophenone compound, a thioxanthone compound, and a triazine compound may be used as the photoinitiator.

In some embodiments, the benzoin compound may include a benzoin, a benzoin methylether, a benzoin ethylether, etc.

In some embodiments, the thioxanthone compound may include 2-isopropyl-thioxanthone, 4-isopropyl-thioxanthone, 2,4-diethyl-thioxanthone, etc.

In some embodiments, the triazine compound may include 2,4-trichloromethyl-(4-methoxy-styryl)-6-triazine, 2,4-bis (trichloromethyl)-6-(4-methoxy-naphthyl)-1,3,5-triazine, 2,4-bis (trichloromethyl)-6-(4-methoxy-naphthyl)-1,3,5-triazine, etc.

In some embodiments, the polymer binder may be one selected from a group of a polyamide polymer binder, a polythioether polymer binder, and a polycyanurate polymer binder.

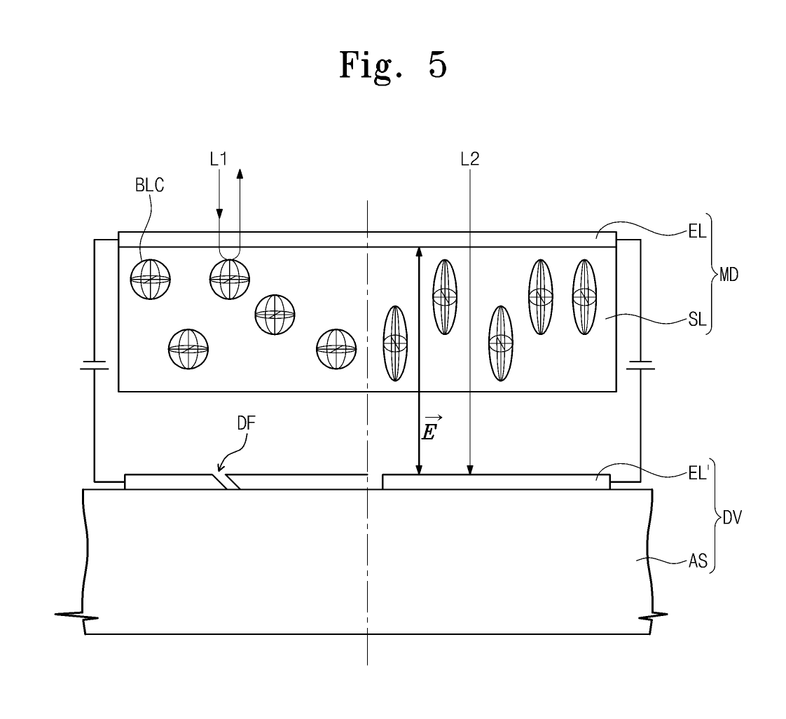

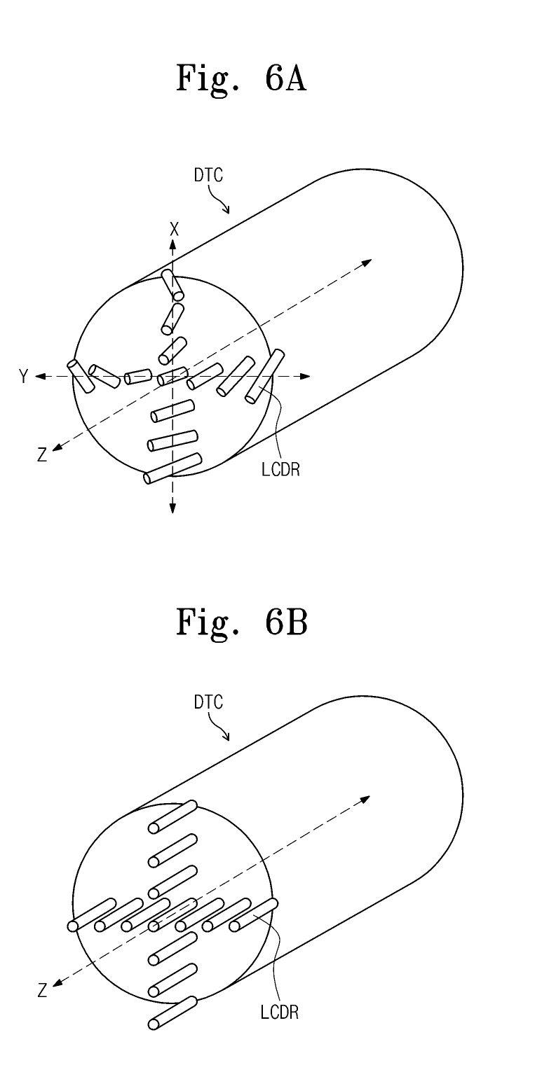

FIG. 5 is a diagram schematically illustrating a driving principle of a liquid crystal modulator MD, according to an exemplary embodiment. FIGS. 6A and 6B are diagrams showing structures of the blue phase liquid crystals according to whether an electric field E is provided, according to an exemplary embodiment. In FIG. 5, components not described may conform to the above-described embodiments.

A defective pixel and a normal pixel is illustrated in FIG. 5. A target electrode EL′ placed at a left side has a defect DF, and a target electrode EL′ placed at a right side is a normal pixel. In FIG. 5, the defect DF is only exemplary, thus, the kind of defects is not limited thereto. For example, some components (e.g., driving circuits, lines, etc.) other than the target electrode EL′ may have a defect.

Referring to FIGS. 5 and 6A, in the event that a voltage is not applied to the target electrode EL′ due to a defect DF of a driving circuit or an target electrode EL′ of pixels of the display substrate DV, no electric field E is formed between the target electrode EL′ and the opposite electrode EL. In this case, the blue phase liquid crystal BLC is in an optical isotropic state, and has a reflection characteristic.

At this occurance, the blue phase liquid crystals BLC have the liquid crystal directors LCDR which are arranged in shape of a double helix structure to form a double twist cylinder DTC. The liquid crystal directors LCDR are disposed within the double twist cylinder DTC to be twisted along two axes (e.g., x-axis and y-axis) perpendicular to each other. In particular, the liquid crystal directors LCDR are disposed so as to be gradually twisted toward an outer side of the double twist cylinder DTC from a center axis (e.g., z-axis). Thus, the blue phase liquid crystals BLC may have directionality within the double twist cylinder DTC on the basis of the center axis of the double twist cylinder DTC.

Therefore, although a light L1 is incident onto the liquid crystal modulator MD, the light L1 is reflected by the blue phase liquid crystal. The reflected light L1 arrives at a measurement unit MU (See FIG. 1) through a beam splitter BS (See FIG. 1). In this case, if a polymer-stabilized blue phase liquid crystals BLC are used as a sensor layer SL, it has a reflection characteristic. Thus, it is unnecessary to form a reflection layer separately.

Referring to FIGS. 5 and 6B, if voltages are applied to the target electrode EL′ of the display substrate DV and the opposite electrode EL of the liquid crystal modulator MD, an electric field E may be formed between the target electrode EL′ and the opposite electrode EL. Thus, the blue phase liquid crystals BLC interposed between the display substrate DV and the liquid crystal modulator MD may be driven. In this case, as illustrated in FIG. 6B, the liquid crystal directors LCDR are arranged in parallel with the center axis (z-axis) of the double twist cylinder DTC by the electric field E. Thus, the blue phase liquid crystals BLC may have a refractive index anisotropy in a predetermined direction, and may transmit a light L2 when the light L2 is incident onto the liquid crystal modulator MD.

As above described, the blue phase liquid crystal according to an exemplary embodiment may have a reflection characteristic when an electric field is not applied thereto.

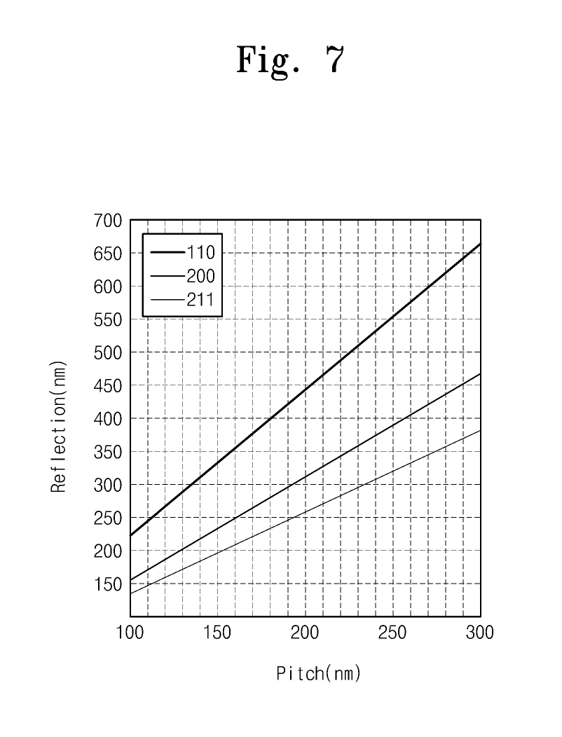

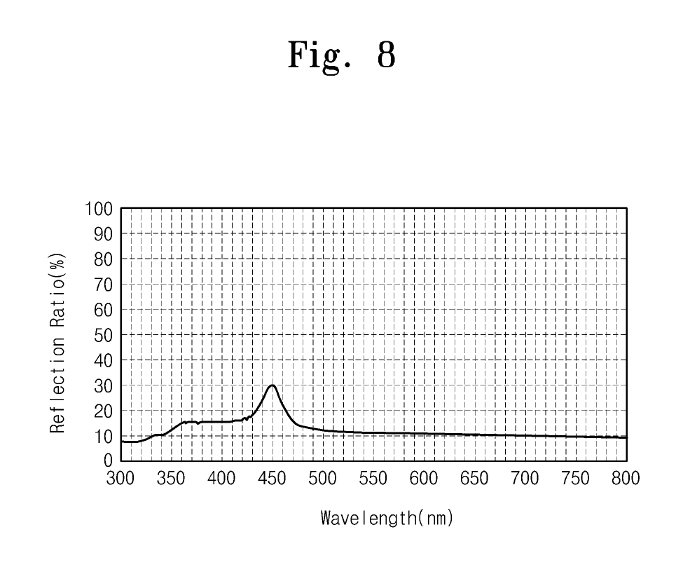

FIG. 7 is a graph showing a wavelength of a reflection peak according to a pitch of a blue phase liquid crystal. FIG. 8 is a graph showing a reflection ratio of a wavelength of a blue phase liquid crystal according to an exemplary embodiment. In FIG. 8, an x-axis may indicate a wavelength (nm), and a y-axis may indicate a reflection ratio (%).

A reflection peak wavelength λₚₑₐₖ of a blue phase liquid crystal according to an exemplary embodiment may be expressed by the following equation 1.

$${λ}_{peak} = \frac{2 na}{\sqrt{{h}^{2} + {k}^{2} + {l}^{2}}} \qquad Equation 1$$

In Equation 1, n is an average reflection ratio of the blue phase liquid crystal, and a indicates a pitch of the blue phase liquid crystal. In Equation 1, h, k, and l indicate three integers included in a Miller index when each plane of a cube defined by the blue phase liquid crystal is expressed by the Miller index.

Referring to Equation 1 and FIG. 7, if a cube is defined by the blue phase liquid crystal having a body-centered cubic lattice structure, each edge of the cube may be defined by the pitch (a) of the blue phase liquid crystal, and each plane of the cube may be expressed by the Miller index. For example, in FIG. 7, a (110) plane is a plane where h, k, and l of the miller index are 1, 1, and 0. A (200) plane is a plane where h, k, and l of the miller index are 2, 0, and 0. A (211) plane is a plane where h, k, and l of the miller index are 2, 1, and 1. Referring to Equation 1 and FIG. 7, the reflection wavelength may be variable according to a pitch of the blue phase liquid crystal and each plane of the cube. In some embodiments, it is possible to easily adjust a final reflection ratio and a reflection wavelength of the liquid crystal modulator using the above-described property of the blue phase liquid crystal.

Referring to FIG. 8, the refractive index anisotropy of the blue phase liquid crystal according to an exemplary embodiment may be more than about 0.1, a pitch of the blue phase liquid crystal may be between about 270 nm and about 300 nm, and a wavelength of a reflection peak of the blue phase liquid crystal may be placed between about 400 nm and about 500 nm. In the event that the blue phase liquid crystal uses a first blue phase liquid crystal BP1 (refer to FIG. 3) and a (200) plane, a reflection peak may be generated at about 450 nm and a pitch may correspond to about 290 nm. In this case, a response speed of a polymer-stabilized blue phase liquid crystal may be less than or equal to about 1 ms.

According to an exemplary embodiment, lights may be reflected or transmitted according to whether an electric field is applied. A measurement unit may generate data signals respectively corresponding to the reflected lights. Then, an image processing unit may generate images respectively corresponding to the data signals. As a result, an operator may determine a defect of a display substrate based on the images thus generated.

In some embodiments, the blue phase liquid crystal may be used as a reflection layer when no electric field is applied. In the event that the polymer-stabilized blue phase liquid crystal is used as a sensor layer, a structure of the liquid crystal modulator and a fabricating process may be simple. In particular, since a reflection layer of a conventional liquid crystal modulator is formed of a dielectric minor, there is needed a step of stacking insulation layers having different reflection ratios in turn. On the other hand, in some embodiments, it is possible to skip a process of forming the reflection layer.

As compared to a conventional liquid crystal (e.g., twisted nematic liquid crystal), a response speed of the polymer-stabilized blue phase liquid crystal may be superior, a detection capacity may be improved, and an elastic suppression capacity may be superior. In particular, a continuous development on a high-definition display device may necessitate an inspection apparatus capable of testing the high-definition display device. Test efficiency of a conventional inspection apparatus about the high-definition display device may be very low. For example, in a display device where a pixel has a one-direction length of 64 um, pixels, tested, from among pixels of the display device may be less than 50%. However, a test capacity of the inspection apparatus according to an exemplary embodiment may be remarkably improved as compared to a conventional display device. In particular, it is possible to detect a defect of a display device where a pixel has a one-direction length of about 30um.

In addition, it is unnecessary to form an alignment film for aligning a liquid crystal layer. Thus, since a high-temperature hardening process is skipped, first and second substrates may be variously selected. For example, a plastic material having a low glass transitions temperature may be used as a material for the first and second substrates.

While the embodiments have been described with reference to exemplary embodiments, it will be apparent to those skilled in the art that various changes and modifications may be made without departing from the spirit and scope of the present embodiments. Therefore, it should be understood that the above exemplary embodiments are not limiting, but illustrative.

What is claimed is:

1. A liquid crystal modulator for an inspection apparatus to detect a defect of a substrate, comprising:
a first substrate;
an electrode provided on the first substrate; and
a sensor layer provided between the first substrate and the electrode,
wherein the sensor layer includes a polymer-stabilized blue phase liquid crystal.

2. The liquid crystal modulator of claim 1, wherein the polymer-stabilized blue phase liquid crystal comprises a blue phase liquid crystal, a reactive mesogen, and a polymer binder.

3. The liquid crystal modulator of claim 2, wherein the ratio of the blue phase liquid crystal to the reactive mesogen is in a range from 6:4 to 8:2 by weight.

4. The liquid crystal modulator of claim 3, wherein the polymer binder is one selected from a group of a polyamide polymer binder, a polythioether polymer binder, and a polycyanurate polymer binder.

5. The liquid crystal modulator of claim 2, wherein the blue phase liquid crystal has a refractive index anisotropy more than about 0.1.

6. The liquid crystal modulator of claim 2, wherein the blue phase liquid crystal has a pitch between about 270 nm and about 300 nm.

7. The liquid crystal modulator of claim 2, wherein the blue phase liquid crystal has a wavelength of a reflection peak between 400 nm and 500 nm.

8. The liquid crystal modulator of claim 1, wherein the first substrate is one selected from a group of quartz, glass, and plastic.

9. The liquid crystal modulator of claim 1, further comprising:
an insulation layer provided between the electrode and the polymer-stabilized blue phase liquid crystal layer.

10. The liquid crystal modulator of claim 1, further comprising:
a second substrate provided on the electrode to support the electrode.

11. The liquid crystal modulator of claim 10, further comprising:
a third substrate provided on the second substrate with an adhesive being interposed between the second substrate and the third substrate.

12. The liquid crystal modulator of claim 11, further comprising:
an anti-reflection layer provided on the third substrate.

13. An inspection apparatus which detects a defect of a substrate, comprising:
a liquid crystal modulator provided on the substrate;
a light emitting unit provided to be spaced apart from the liquid crystal modulator;
a beam splitter provided between the liquid crystal modulator and the light emitting unit, wherein the beam splitter is configured to reflect a light from the light emitting unit to the liquid crystal modulator; and
a measurement unit opposite to the liquid crystal modulator with the beam splitter being interposed between the measurement unit and the liquid crystal modulator, wherein the measurement unit is configured to sense a light from the liquid crystal modulator,
wherein the liquid crystal modulator comprises:
a first substrate;
an electrode provided on the first substrate; and
a sensor layer provided between the first substrate and the electrode,
wherein the sensor layer includes a polymer-stabilized blue phase liquid crystal.

14. The inspection apparatus of claim 13, further comprising:
a focusing unit provided between the beam splitter and the measurement unit and focusing the light.

15. The inspection apparatus of claim 13, further comprising:
an image processing unit converting a signal generated by the measurement unit into an image.
